(19) United States
(12) Patent Application Publication
(10) Pub. No.: US 2015/0254620 A1
(43) Pub. Date: Sep. 10, 2015

(54) SALE ARTICLE SETTLEMENT TERMINAL AND PRODUCT TIME LIMIT NOTIFICATION SYSTEM

(71) Applicant: TOSHIBA TEC KABUSHIKI KAISHA, Tokyo (JP)

(72) Inventor: Ko Tei, Izunokuni (JP)

(21) Appl. No.: 14/631,923

(22) Filed: Feb. 26, 2015

(30) Foreign Application Priority Data
Mar. 5, 2014 (JP) 2014-042937

(51) Int. Cl. G06Q 20/20

(52) U.S. Cl. CPC G06Q 20/20

(57) ABSTRACT

According to an embodiment, there is provided a sale article settlement terminal including a temporary data storage unit that temporarily stores payment target product information, which is extracted from sale product information, and payment target customer information which is extracted from the sale customer information; a purchase price calculation unit that calculates settlement price of the payment target product which is stored in the temporary data storage unit; a transaction data preparing unit that prepares transaction data which is trading data including product time limit data of the payment target product; and a transaction data numbering unit that performs numbering of the prepared transaction data.

### CROSS-REFERENCE TO RELATED APPLICATION

This application is based upon and claims the benefit of priority from Japanese Patent Application No. 2014-042937, filed Mar. 5, 2014, the entire contents of which are incorporated herein by reference.

### FIELD

Embodiments described herein relate generally to a sale article settlement terminal and a product time limit notification system which inform the expiration date of a purchased product to a customer.

### BACKGROUND

Time limits, such as consumption time limits or expiration dates, are set for a lot of types of food in many cases. In the case of raw food, such as raw sliced fish, a consumption time limit is the day of sale in many cases, and a customer also recognizes that it is necessary to eat the raw food on that day and seldom forgets such a consumption time limit date. However, when there are few days until the consumption time limit, there is a case in which the food is not completely eaten on the day of purchase and is stored. In such a case, the food is stored and the consumption time limit is forgotten, and, as a result, the consumption time limit is exceeded and the food is discarded. In order to prevent this, a system, which recognizes mail from a mobile phone that reads a matrix type 2-dimensioanl bar code attached on a product and which provides notification of the use-by time limit date of the product to the mobile phone, is known.

However, there are various kinds of products to which consumption time limits or the like are set. Further, when a plurality of products to which consumption time limits are set are purchased at once, there is a problem in that it takes time to recognize the products using the mobile phone.

### DESCRIPTION OF THE DRAWINGS

FIG. 1 is a diagram illustrating an example of the configuration of a system according to an embodiment.

FIG. 2 is a diagram illustrating an example of the configuration of a POS terminal of the system according to the embodiment.

FIG. 3 is a diagram illustrating an example of the configuration of a server of the system according to the embodiment.

FIG. 4 is a diagram illustrating an example of customer information which is stored according to the embodiment.

FIG. 5 is a flowchart illustrating data processing performed by the system according to the embodiment at the point of time that a product is sold.

FIG. 6 is a diagram illustrating an example of product information which is stored according to the embodiment.

FIG. 7 is a diagram illustrating an example of transaction information according to the embodiment.

FIG. 8 is a diagram illustrating an example of customer information which is stored according to the embodiment.

FIG. 9 is a flowchart illustrating the data processing performed by the system according to the embodiment in order to extract a notification target product.

FIG. 10 is a diagram illustrating an example of a time limit date approach notification display screen of the system according to the embodiment.

FIG. 11 is a diagram illustrating an example of the configuration of a POS terminal of a system according to a second embodiment.

FIG. 12 is a flowchart illustrating data processing performed by the system according to the second embodiment at the point of time that a product is sold.

### DETAILED DESCRIPTION

According to an embodiment, there is provided a sale article settlement terminal and a product time limit notification system which provide notification of the consumption time limit of a product to a consumer who purchased the product.

According to another embodiment, there is provided a sale article settlement terminal including: a temporary data storage unit that temporarily stores payment target product information, which is extracted from sale product information, and payment target customer information which is extracted from sale customer information; a purchase price calculation unit that calculates settlement price of the payment target product which is stored in the temporary data storage unit; a transaction data preparing unit that prepares transaction data which is trading data including product time limit data of the payment target product; and a transaction data numbering unit that performs numbering of the prepared transaction data.

### First Embodiment

Hereinafter, a product time limit notification system according to a first embodiment will be described with reference to the accompanying drawings.

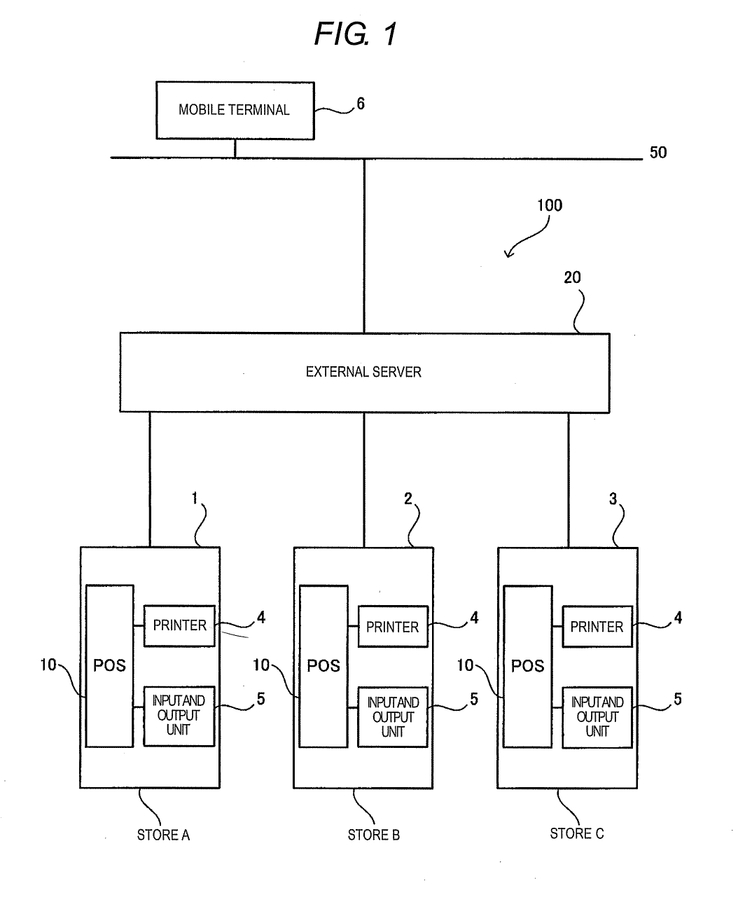

FIG. 1 illustrates an example of the configuration of a system according to the embodiment. Meanwhile, in the embodiment, a product time limit is described as a consumption time limit of a product. However, it is not limited to this and may be the expiration date of a product, or the like.

A product time limit notification system 100 includes an external server 20 which is connected to a public line 50 or the like and which manages customer information, purchased product transaction information, or the like, a store A1, a store B2 and a store C3 which are connected to the external server 20 through a network, and the mobile terminal 6 of a customer.

The store A1 is an article sale store, such as a supermarket. A printer 4, which outputs a receipt after sale article settlement is performed, is connected to an input and output unit 5, which exchanges data of the mobile terminal 6 of the customer with a Point Of Sale (POS) terminal 10 or which acquires a unique product code of a product or customer information, together with the POS terminal 10 which performs settlement, when an article is sold, as a sale article settlement terminal.

In addition, the store B2 and the store C3 also include the POS terminal 10, the printer 4, and the input and output unit 5, similarly to the store A1.

Here, although description is made in which the number of article sale stores is 3, there is no problem when the number of stores in the system is one, two, or four or more.

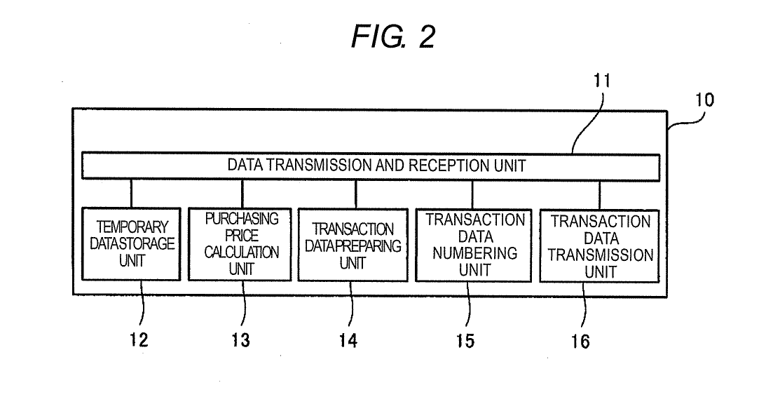

FIG. 2 illustrates the POS terminal 10 as the sale article settlement terminal, in detail. The POS terminal 10 includes a temporary data storage unit 12 that temporarily stores information related to a purchasing article which is carried to a cash register by an article purchasing customer or the customer number of a customer which will be described later, a purchase price calculation unit 13 that calculates the settlement price of the purchasing article, a transaction data preparing unit 14 that prepares transaction data which is transaction information, the settlement of which is completed, a transaction data numbering unit 15 that performs numbering of a transaction data number for each prepared transaction data, and a transaction data transmission unit 16 that transmits the transaction data, which is prepared by the transaction data preparing unit, 14 and the transaction number, which is acquired by performing numbering of the transaction data numbering unit 15, to the external server 20 which will be described later. In addition, a data transmission and reception unit 11 that transmits or receives data to or from the outside is provided.

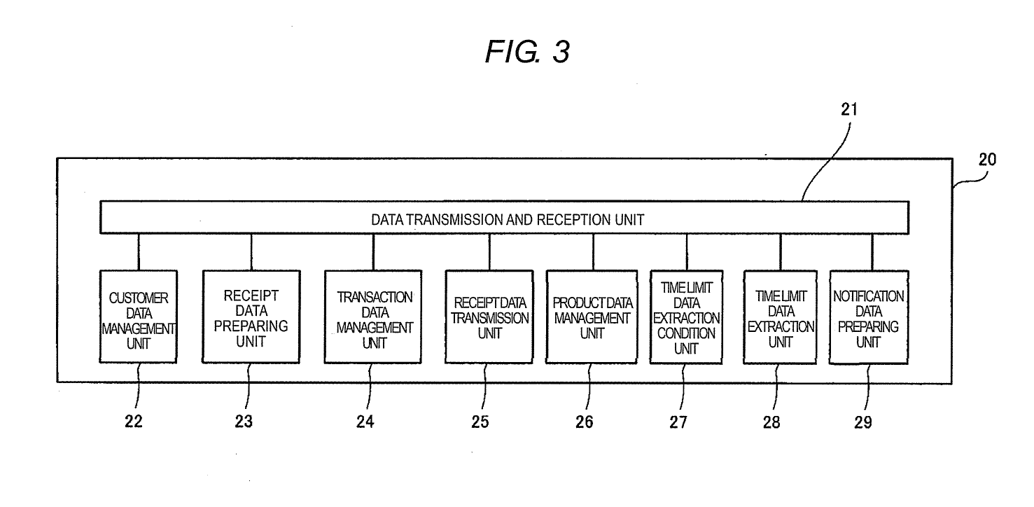

Subsequently, FIG. 3 illustrates the external server 20 in detail. The external server 20 includes a customer data management unit 22 that manages customer information, a receipt data preparing unit 23 that prepares receipt data on the basis of the transaction data, a transaction data management unit 24 that manages the transaction data, a receipt data transmission unit 25 that transmits the receipt data to the mobile terminal 6 of the customer, a product data management unit 26 that manages information about a product to be sold, a time limit data extraction condition unit 27 that manages an extraction condition for extracting time limit data when a time limit is notified, a time limit data extraction unit 28 that extracts the time limit data under the extraction condition of the time limit data extraction condition unit 27, and a notification data preparing unit 29 that prepares a notification mail on the basis of the extracted time limit data and transmits the notification mail to the mobile terminal of the customer. In addition, a data transmission and reception unit 21 that transmits or receives data to or from the outside is provided.

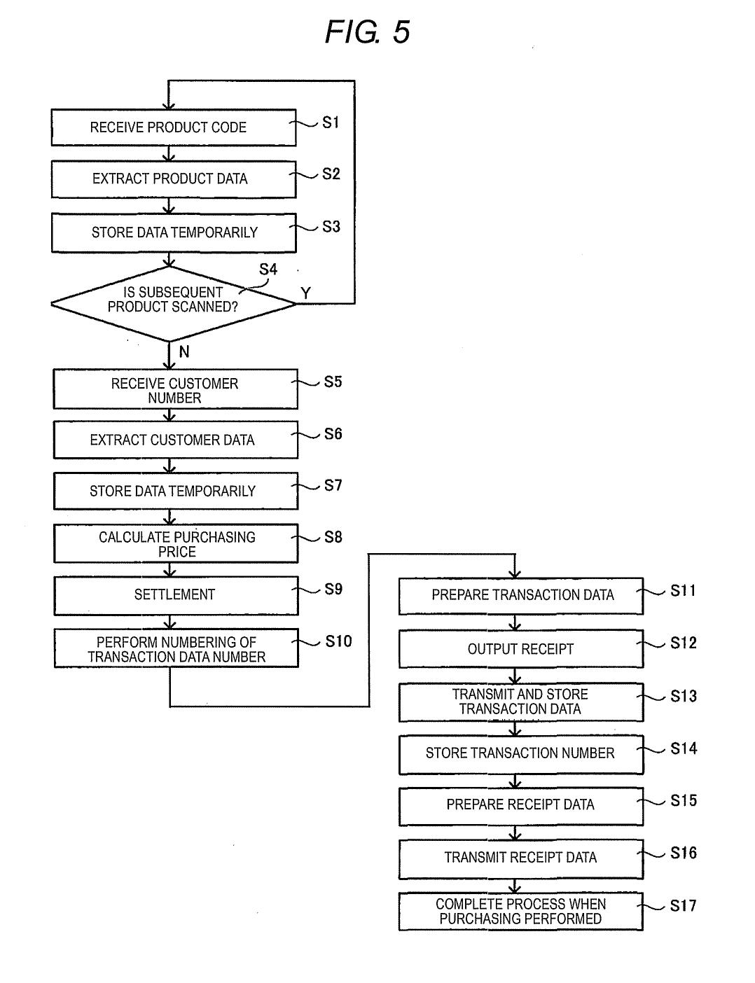

Hereinafter, a product sale performed when the product time limit notification system is used will be described with reference to FIGS. 2 to 8.

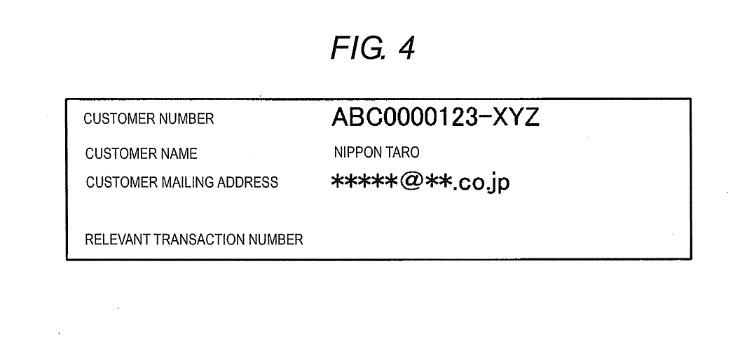

A customer who uses the system does not perform member registration in advance, and customer information data, which is illustrated as an example in FIG. 4, is stored in the customer data management unit 22 of the external server 20. Meanwhile, a relevant transaction number indicates the past transaction number of the customer, and the relevant transaction number is not present when a new member is registered.

The article purchasing customer carries a desired article to be purchased to a cash register. Meanwhile, description will be made based on the assumption that the current shopping date is Feb. 1, 2014.

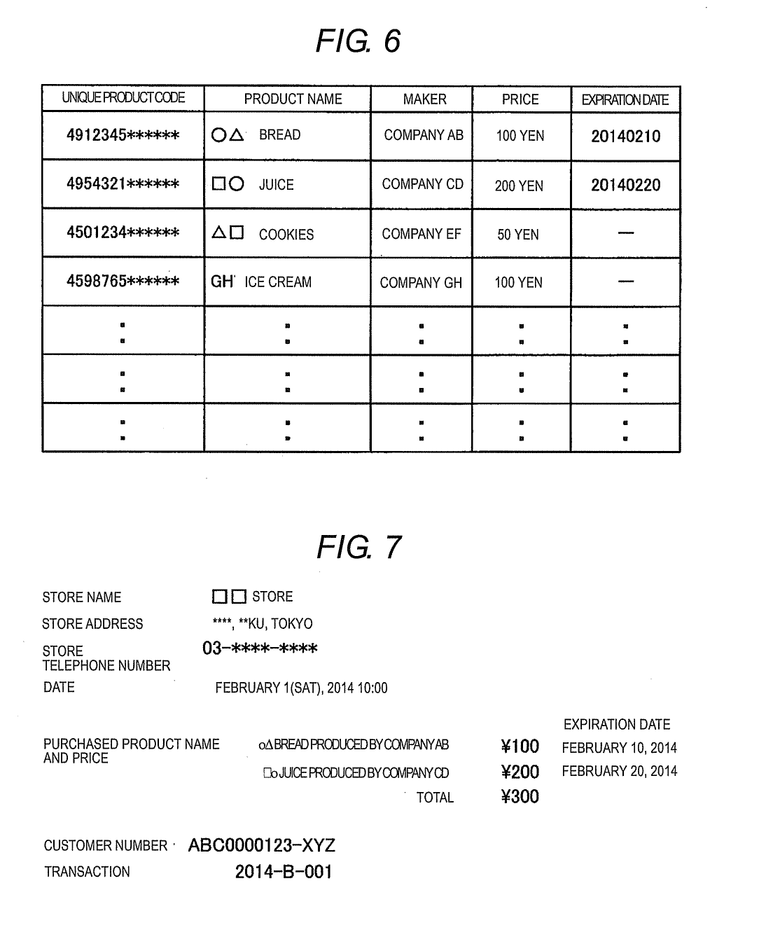

An operator of the store A1 scans a purchasing article using, for example, the input and output unit 5, such as a scanner, which is connected to the POS terminal 10, and receives a unique product code (Act1). Subsequently, the operator of the store A1 transmits the unique product data to the product data management unit 26 which is provided in the external server 20. The product data management unit 26 stores the product data of all products which are handled in the store and which are shown in FIG. 6 as an example. Meanwhile, in the embodiment, description will be made based on the assumption that oΔ bread and □o juice, shown in FIG. 6 which will be described later, are purchased.

The product data management unit 26 extracts the product data corresponding to the received unique product code (Act2), and stores the product data in the temporary data storage unit 12 (Act3).

Here, when a plurality of products is purchased, a subsequent product is scanned (Act4). When a subsequent product scanning exists (Y in Act4), product code reception (Act1), product data extraction (Act2), and temporal data storage (Act3) are repeated again.

When the scanning of all the desired articles to be purchased, which are carried to the cash register by the article purchasing customer, is completed, a subsequent product to be scanned does not exist (N in Act4). Since the scanning of all the products is completed, the customer delivers a customer card in which customer information is written to the operator. The operator scans the customer card using the input and output unit 5 and receives a customer number (Act5). Subsequently, the operator transmits the customer number to the customer data management unit 22 which is provided in the external server 20. The customer data management unit 22 extracts customer data corresponding to the received customer number (Act6), and stores the customer data in the temporary data storage unit 12 (Act7). Meanwhile, in the embodiment, the customer card is accepted in order to receive the customer information. However, it is not necessarily limited to the customer card. For example, a method of displaying a customer member code on the display screen of a mobile phone, which is possessed by a customer, using a code symbol and having the operator read the customer member code using the input and output unit 5 may be provided.

Subsequently, the purchase price calculation unit 13 of the POS terminal 10 calculates a purchase price, which is a settlement price, using the product data which is stored in the temporary data storage unit 12 (Act8).

Subsequently, the operator receives money from the customer, and completes the settlement (Act9).

When the settlement is completed, the transaction data numbering unit 15 performs numbering of the transaction data number of current trading (Act10), and the transaction data preparing unit 14 of the POS terminal 10 continuously prepares transaction data, which is shown in FIG. 7 as an example, based on the purchasing article data, the customer number, the store information, and the like which are stored in the temporary data storage unit 12 (Act11).

Subsequently, a receipt is output by the printer 4 of the POS terminal 10 (Act12) and the receipt is delivered to the customer. Meanwhile, although a receipt is output, it is possible to stop the output of the receipt by transmitting the data of receipt information to the mobile phone of the customer, which will be described later. In addition, it is possible to arbitrarily select whether or not to output the receipt, such as a receipt output and data transmission by the side of the store.

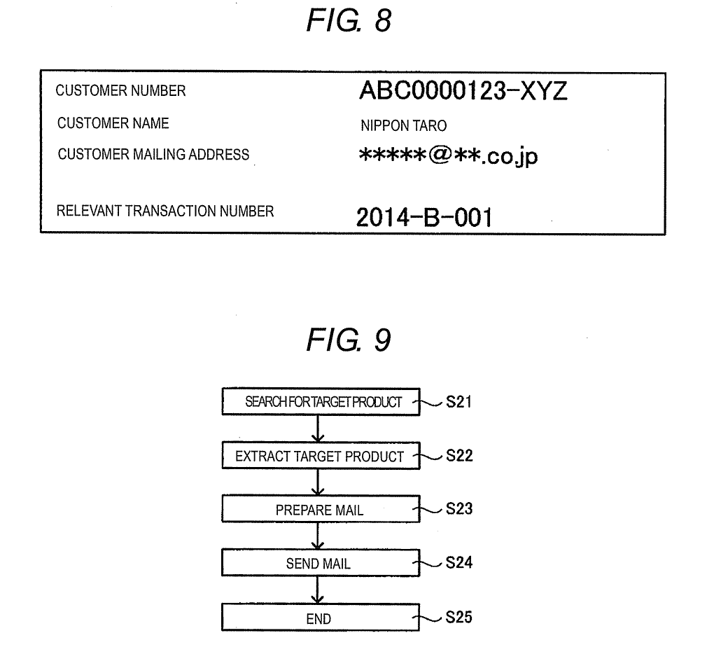

subsequently, the transaction data transmission unit 16 of the POS terminal 10 transmits and stores the transaction data to and in the transaction data management unit 24 of the external server 20 (Act13), and, simultaneously, and writes the current transaction number in the relevant transaction number field of the customer information as shown in FIG. 8 as an example, to store the current transaction number in the customer data management unit 12 (Act14).

Subsequently, the receipt data preparing unit 23 prepares the receipt data of the purchased product based on the transaction data (Act15), and transmits the receipt data of the purchased product to the mailing address of the customer using the receipt data transmission unit 25 (Act16).

As above, a process, performed When a product is purchased, ends (Act17).

Subsequently, time limit target product notification will be described with reference to FIGS. 3, 9, and 10.

The time limit data extraction condition unit 27 of the external server 20 stores an extraction condition in order to extract a target product to which a time limit is notified in the product time limit notification system. For example, the extraction condition includes a condition in which a target product is extracted in order to provide notification three days before the expiration date in the case of food, and an extraction condition in which a target is extracted two days before the expiration date in the case of products produced by a company GH, and it is possible to arbitrarily set a plurality of extraction conditions by the side of the store.

The time limit data extraction unit 28 of the external server 20, regularly searches for data of the transaction data management unit 24 as a target using the extraction condition which is stored in the time limit data extraction condition unit 27, and checks whether or not a target product exists. In the embodiment, description is made in which it is assumed that setting is made such that bread produced by a company AB is extracted three days before the consumption time limit in the time limit data extraction condition unit 27 in order to provide notification.

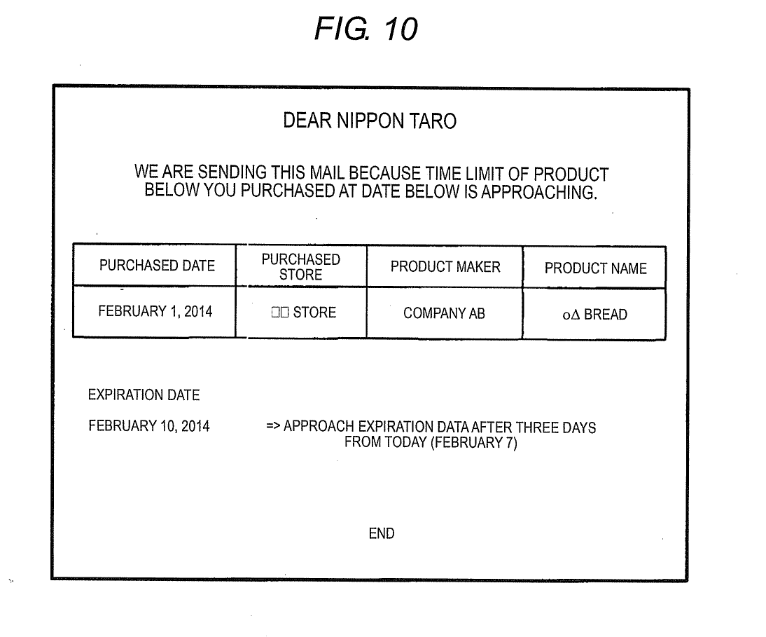

At a point of time dated Feb. 7, 2014, when the time limit data extraction unit 28 searches for the target product under the time limit data extraction condition (Act21), oΔ bread which is produced by the company AB and which is purchased on Feb. 1, 2014 by a customer who has a customer number ABC0000123-XYZ is extracted as the target product (Act22). Subsequently, the notification data preparing unit 29 prepares a mail shown in FIG. 10 as an example based on the extracted information (Act23), sends a mail, which informs that the time limit is approaching, to the mail address of a Nippon Taro who has the customer number ABC0000123-XYZ (Act24), and the time limit notification in the product time limit notification system ends (Act25).

As above, in the product time limit notification system according to the embodiment, a product, the time limit of which is approaching, is extracted, and a mail, which informs that the time limit is approaching, is sent to a purchasing customer, and thus it is possible to prevent the customer who received the mail from discarding a product because the customer forgets the time limit date.

### Second Embodiment

Hereinafter, a product time limit notification system according to a second embodiment will be described in detail with reference to the accompanying drawings. Meanwhile, the same reference numerals are attached to the same components as in the first embodiment, and the description thereof will not be repeated.

In the first embodiment, description is made in such a way that oΔ bread and □o juice shown in FIG. 6 are purchased. The expiration date of products of oΔ bread and □o juice are set in advance, and are stored in the product data management unit 26. However, products, which have the same unique product codes, may have different dates of manufacture and all of the expiration dates may not be the same according to products. Further, there is a product, the expiration date of which does not exist, similarly to ice cream.

In such a case, it is difficult to acquire time limit information by performing scanning on a product once. In the second embodiment, a time limit setting unit is further provided, a time limit date is set even when the time limit date is not set in the product data management unit 26, and a mail, which informs that the time limit is approaching, is sent based on the expiration date.

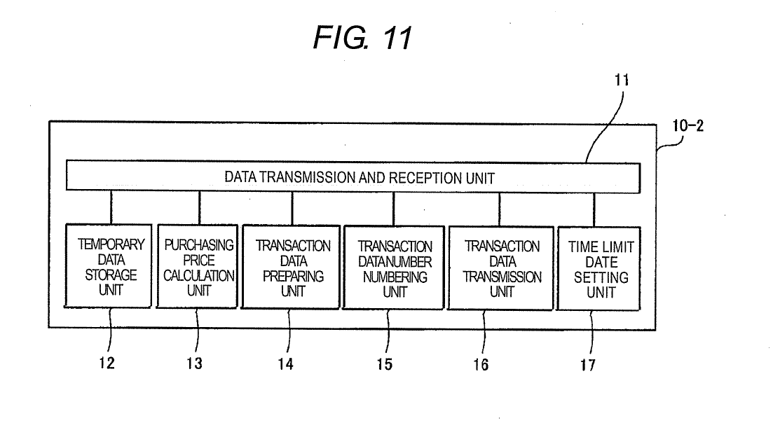

FIG. 11 illustrates a POS terminal 10-2 according to the second embodiment in detail. The POS terminal 10-2 according to the second embodiment is further provided with a time limit date setting unit 17 with regard to the POS terminal 10 according to the first embodiment.

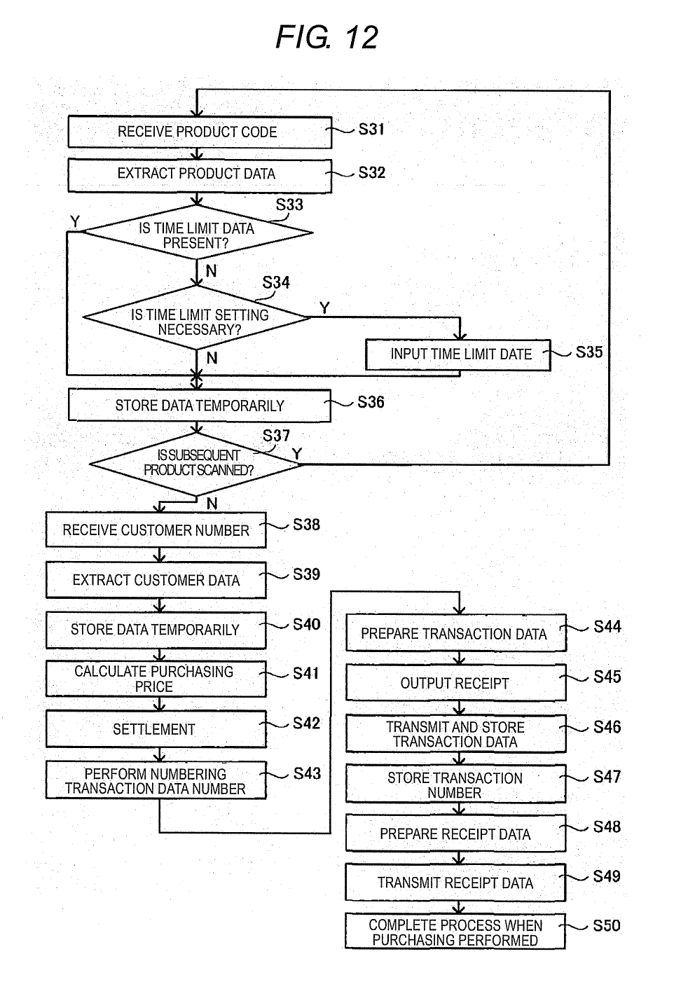

Hereinafter, the flow of product sales, performed when the product time limit notification system according to the second embodiment is used, will be described with reference to a flowchart in FIG. 12.

A customer who uses the system performs member registration in advance similarly to the first embodiment.

An article purchasing customer carries a desired article to be purchased to a cash register. Meanwhile, description will be made based on the assumption that the current date is Feb. 1, 2014.

An operator of the store Al scans a purchasing article using, for example, the input and output unit 5, such as a scanner, which is connected to the POS terminal 10-2, and receives a unique product code (Act31). Subsequently, the operator of the store A1 transmits unique product data to the product data management unit 26 which is provided in the external server 20. The product data management unit 26 stores the product data of all products, which are shown in FIG. 6 as examples, and which are handled in the store. Meanwhile, in the embodiment, description will be made based on the assumption that oΔ bread, a Δ□ cookie, and GH ice cream, shown in FIG. 6, are purchased.

The product data management unit 26 extracts the product data corresponding to the received unique product code (Act32) Here, the product data management unit 26 checks whether or not the time limit data is written in the time limit data writing part of stored data (Act33). For example, when oΔ bread produced by the company AB is scanned, the time limit is written (Y in Act33), and thus the data of the target product is stored in the temporary data storage unit 12 (Act36).

For example, when a Δ□cookie produced by a company EF is scanned, the time limit is not written, and thus a result of checking whether or not the time limit data is written (Act33) is no data (N in Act33).

Subsequently, it is determined whether or not it is necessary to set the time limit here by the side of a time limit store in advance. When it is necessary to set the time limit (Y in Act34), the time limit date is input by the time limit date setting unit 17 (Act35). Meanwhile, as an expiration date input method, the time limit date may be acquired by inputting the time limit date printed on a packaging bag using a key board, which is not shown in the drawing, of the POS terminal 10-2, or scanning another code data, which includes the time limit date and which is provided in a separate store, in addition to code data, such as a bar code, which specifies a unique product code by the input and output unit 5. After the time limit data is acquired, the product data which includes the time limit data is stored in the temporary data storage unit 12 (Act36).

For example, when ice cream produced by a company GH is scanned, the time limit is not recorded. Therefore, a result of check whether or not the time limit data is written (Act33) is no data (N in Act33).

It is determined whether or not it is necessary to set the time limit here in advance by the side of the time limit store. For example, an expiration date is not set for ice cream. Accordingly, it is not necessary to set the time limit (N in Act34), and thus the product data, which does not include the time limit data, is stored in the temporary data storage unit 12 without entering the time limit data (Act36). In addition to the product to which an expiration date or the like is not set similarly to ice cream, there is a product in which, for example, a consumption time limit is considerably long according to a product, and it is estimated that the product is probably consumed until the consumption time limit. Therefore, an operation is conceivable in which the expiration date is not notified intentionally. In such a case, it is not necessary to set the time limit (N in Act34). It is possible to arbitrarily make setting such that it is not necessary to set the time limit by the side of the store.

When a plurality of products are purchased, subsequent product scanning is performed (Act37). When subsequent product scanning exists (Y in Act37), product code reception (Act31), product data extraction (Act32), and existence or non-existence of time limit data, checking (Act33), and the like are repeated again.

When the scanning of all the desired articles to be purchased, which are carried to the cash register by the article purchasing customer, is completed, a subsequent product to be scanned does not exist (N in Act37). Since the same process as in the first embodiment is performed hereinafter, the description thereof will not be repeated. In addition, since the extraction and notification of a target product in which the time limit is approaching are the same processes as in the first embodiment, the description thereof will not be repeated.

As described above, in the second embodiment, it is possible to arbitrarily input a time limit for a product, in which time limit information is not recorded in product information in advance, using the time limit date setting unit 17. Therefore, it is possible to input correct time limits even when products which have the same unique product code and different time limits exist, and it is possible to provide time limit date approaching information corresponding to the time limit. In addition, since it is possible to set whether or not to set the time limit, it is possible to prevent an incorrect time limit from being input for a product in which the time limit does not exist and, simultaneously, it is possible to perform an operation in which the time limit date is intentionally not set.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sale article settlement terminal comprising:
a temporary data storage unit that temporarily stores payment target product information, which is extracted from sale product information, and payment target customer information which is extracted from sale customer information;
a purchase price calculation unit that calculates a settlement price of the payment target product which is stored in the temporary data storage unit;
a transaction data preparing unit that prepares transaction data which is trading data including product time limit data of the payment target product; and
a transaction data numbering unit that performs numbering of the prepared transaction data.

2. The terminal according to claim 1 further comprising:
a time limit date setting unit that sets time limit date information for the payment target product information which is extracted from the sale product information stored in the temporary data storage unit.

3. A product time limit notification system comprising:
a mobile terminal;
a sale article settlement terminal that includes a temporary data storage unit which stores data of a purchasing article, a purchase price calculation unit which calculates a settlement price of the purchasing article, a transaction data preparing unit which prepares trading data of the purchasing article, a transaction data numbering unit which performs numbering of prepared transaction data, and a transaction data transmission unit which transmits the transaction data; and
a server that includes a transaction data management unit which stores and manages the transaction data received from the sale article settlement terminal, a receipt data preparing unit that prepares receipt data to be transmitted to the mobile terminal based on the transaction data, a customer data management unit which manages sale customer information, a product data management unit which manages data of a product to be sold, a time limit data extraction unit which extracts time limit data from a sold product under a predetermined condition, and a notification data preparing unit which transmits the extracted time limit data information to the mobile terminal.

4. The system according to claim 3 further comprising:
a time limit date setting unit that sets a time limit date of the product to be sold.
